(19) United States
(12) Patent Application Publication
(10) Pub. No.: US 2009/0261969 A1
(43) Pub. Date: Oct. 22, 2009

(54) VEHICLE STATE NOTIFYING SYSTEM, ITS CONSTITUENT DEVICE, AND NOTIFYING METHOD

(75) Inventor: Kaoru Kobayashi, Saitama (JP)

Correspondence Address: INGRASSIA FISHER & LORENZ, P.C., 7010 E. COCHISE ROAD, SCOTTSDALE, AZ, 85253, US

(73) Assignee: NIHON DEMPA KOGYO CO., LTD., Sayama-shi, Saitama (JP)

(21) Appl. No.: 11/718,197

(22) PCT Filed: Oct. 26, 2005
(86) PCT No.: PCT/JP05/20049

§ 371 Date: Jun. 3, 2009

(30) Foreign Application Priority Data
Oct. 29, 2004 (JP) 2004-317047

(51) Int. Cl. G08B 1/08; B60Q 1/00; G05B 19/00

(52) U.S. Cl. 340/539.11; 340/5.1

(57) ABSTRACT

A vehicle state notifying system for notifying the user of a vehicle state through a simple configuration at a low cost is proved. The notifying system includes a slave device which the user carries and a master device radio-communicatable with the slave device bidirectionally. Upon reception of send request data from the slave device, the master device generates notification data indicating the state of an automobile from the detection result of the state of the automobile detected by various sensors and sends the notification data to the slave device through weak radio. The master device synchronizes the transmission timing of the notification data with the reception operation interval of the slave device.

### CROSS-REFERENCE TO RELATED APPLICATIONS

This application is a U.S. National-Stage entry under 35 U.S.C. § 371 based on International Application No. PCT/JP2005/020049, filed Oct. 26, 2005, which was published under PCT Article 21(2) and which claims priority to Japanese Application No. JP 2004-317047, filed Oct. 29, 2004.

### TECHNICAL FIELD

The present invention relates to a technique of easily notifying a user outside a vehicle, such as an automobile, a two-wheeled motor vehicle, an electric train, and an aircraft, of a state of the vehicle by using a module that uses a weak-power radio which is not restricted by the law. The state of the vehicle indicates whether an engine and another source of power are operated, whether doors are locked, whether measuring instruments are normally operated, and the like.

### BACKGROUND

Examples of information notifying systems using the weak-power radio module include keyless entry systems. Conventional such keyless entry systems are configured by a radio module (master device) mounted to an automobile and a portable radio module (slave device) carried by the user. The slave device sends a control signal having data for locking or unlocking the doors to the master device. The master device is connected to a lock control mechanism for locking or unlocking the doors. When the control signal is received from the slave device (when the control signal is identified by detection), the master device locks or unlocks the doors through the lock control mechanism. Accordingly, even when the user has luggage, the user can lock or unlock the doors without inserting a key into a keyhole of the automobile.

Some of such keyless entry systems are sophisticated, which have a remote engine start function and the like in addition to a door opening/closing function. With those sophisticated keyless entry systems, the user can easily perform a so-called “warming-up operation”, in which the engine is started in advance at the cold time, by starting the engine of the vehicle without getting in the vehicle, thereby further enhancing convenience.

In the conventional keyless entry systems, data is sent in a single direction from the slave device to the master device. Therefore, although the user can lock or unlock the doors of the automobile, the user cannot confirm the current state, that is, whether the doors of the automobile are currently locked.

Even if an abnormality occurs in the automobile because of a “car break-in” or the like while the user is not around the automobile, the conventional keyless entry systems cannot notify the user of the state.

In case of such an abnormality occurred in the automobile, it is conceivable to use a security service in which a sensor and a radio unit are provided for the automobile in advance; when an abnormality actually occurs, the radio unit notifies a security center where a security guard is deployed, of the occurrence of the abnormality; the security guard is instructed to go and confirm the state of the automobile; and the security center notifies the user of a result of the confirmation by phone or the like. However, to realize the service, it is necessary to notify a security center far from the automobile of information indicating an abnormal state. In this case, a license under the Radio Law is necessary to operate the radio unit provided for the automobile, and further, the radio unit itself is expensive. With the maintenance cost of the security center and personnel cost, it is difficult to reduce a service charge, so the use of the security service is not practical.

The present invention provides a vehicle state notifying system capable of notifying the user of the vehicle state with a simple configuration at a low cost.

### SUMMARY

The present invention provides a notifying system that includes a notifying device and a portable terminal device each having a radio communication means for performing bidirectional intermittent communication using weak power which is not restricted by the law.

(Vehicle State Notifying Device)

The notifying device, which is mounted in a vehicle, includes: a radio communication means for performing bidirectional intermittent communication with a portable terminal device by using weak power which is not restricted by a law; a transmission request receiving means for receiving, from the portable terminal device, a transmission request to send information indicating a current state of a vehicle to be monitored, through the radio communication means; a vehicle state detecting means for obtaining a detection result detected by a predetermined sensor, regarding the state of the vehicle corresponding to the transmission request received by the transmission request receiving means; and a control means for controlling an operation of the radio communication means such that the radio communication means intermittently sends notification data having a predetermined data structure, indicating the detection result obtained by the vehicle state detecting means, at an interval at which the portable terminal device can receive the notification data.

In terms of establishing synchronization of intermittent communication, the notifying device further includes a timer for measuring an interval of signals intermittently received from the portable terminal device. In this case, the control means operates so as to control the radio communication means such that the radio communication means establishes synchronization of intermittent communication performed with the portable terminal device based on the interval measured by the timer.

Preferably, the control means is configured to hold the interval measured after the synchronization is established, and to determine whether the synchronization is maintained, by comparing the held interval with an interval measured by the timer at a later signal reception.

In order to enable prompt notification to be made to a user, the vehicle state detecting means is desirably configured to collect the detection result from the sensor at timing not related to communication timing of the intermittent communication with the portable terminal device, to accumulate the detection result in a predetermined memory, and to read out, when the transmission request is received, the accumulated detection result regarding the vehicle state corresponding to the transmission request, from the memory. In terms of improved efficiency of communication, the vehicle state detecting means is configured to obtain the detection result from the sensor in each period, to accumulate the detection result obtained at each period in the memory, and to generate information indicating whether the vehicle state has changed, by comparing a detection result obtained at a preceding period with a detection result obtained at a current period. In this case, the control means is preferably configured to control the radio communication means such that the radio communication means obtains the information indicating whether the vehicle state has changed from the vehicle state detecting means through the intermittent communication, and, when the vehicle state has changed, sends the notification data indicating that the vehicle state has changed to the portable terminal device at timing when communication can be performed immediately after the vehicle state has changed.

(Portable Terminal Device)

A portable terminal device includes: a radio communication means for performing bidirectional intermittent communication with a notifying device which notifies of a vehicle state in response to a request, by using weak power which is not restricted by a law; a transmission request data generating means for generating transmission request data to request, through the radio communication means, the notifying device to send notification data indicating a current state of a vehicle to be monitored; and a control means for controlling an operation of the radio communication means such that the radio communication means intermittently sends the transmission request data generated by the transmission request data generating means to the notifying device at an interval assigned in advance to the portable terminal device, and also receives the notification data sent to the portable terminal device.

In order to enhance availability of operation and operability, the portable terminal device further includes an instruction input receiving means for receiving an instruction inputted by a user. The transmission request data generating means may be configured to generate, when the instruction input receiving means receives the request regarding any section among a plurality of sections to be monitored which are included in the vehicle from the user, transmission request data having a content corresponding to the request. Further, the control means may be configured to control the radio communication means such that the radio communication means performs the intermittent transmission while maintaining a first interval after synchronization with the notifying device is established, and performs the intermittent transmission at a second interval shorter than the second interval in an emergency case where an instruction inputted by the user is received.

Alternatively, the portable terminal device may further include a visualization means whose operation is controlled by the control means, and which visually notifies the user of the vehicle state indicated by the received notification data.

(Vehicle State Notifying Method)

With the notifying system configured as described above, it is possible to notify the user of the vehicle state through, for example, the following multiple steps of:
(1) intermittently sending, by the portable terminal device, transmission request data, to the notifying device, to request for transmission of notification data indicating a current state of a vehicle to be monitored, at an interval assigned to the portable terminal device;
(2) establishing, by the notifying device, synchronization of intermittent communication with the portable terminal device upon reception of the transmission request data, and intermittently sending notification data having a predetermined data structure indicating a detection result regarding the vehicle state obtained through detection of a predetermined sensor, at an interval at which the portable terminal device, which has established synchronization, can receive the notification data; and
(3) notifying, by the portable terminal device, after receiving the notification data, the user of the vehicle state identified by the notification data, by visually expressing the vehicle state.

According to the present invention, it is possible to provide a system capable of notifying the user of the vehicle state with a simple configuration at a low cost.

### BRIEF DESCRIPTION OF THE DRAWINGS

The present invention will hereinafter be described in conjunction with the following drawing figures, wherein like numerals denote like elements, and

FIG. 1 is a schematic explanatory diagram of an automobile state notifying system according to the present invention.

FIG. 2 is a schematic explanatory diagram of the automobile state notifying system according to the present invention.

FIG. 3 is a schematic functional block diagram of a master device.

FIG. 4 is a schematic functional block diagram of a slave device.

FIG. 5 is an explanatory diagram of a format of notification data.

FIG. 6 is an explanatory diagram of a format of transmission request data.

FIG. 7 is an explanatory diagram of intermittent transmission and reception timing between the master device and the slave device.

FIG. 8 is an explanatory diagram of intermittent transmission and reception timing between the master device and the slave device.

FIG. 9 is an explanatory diagram of transmission timing from the slave device to the master device.

FIG. 10 is an explanatory diagram of timing of an automobile state confirmation operation.

FIG. 11 is an explanatory diagram of a format of internal communication data.

FIG. 12 is a flowchart of a processing operation of the master device.

FIG. 13 is a flowchart of a processing operation of the slave device.

FIG. 14 is an outline view of the slave device.

FIG. 15 is an outline view of a slave device according to a modification.

FIG. 16 is an explanatory diagram of intermittent transmission and reception between a master device and a slave device according to another embodiment.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In this embodiment, a description is given by taking an automobile as an example of a vehicle. However, the application of this embodiment is not limited to the automobile. This embodiment can also be applied to another transportation means such as a two-wheeled motor vehicle, an electric train, and a ship. Therefore, the term “vehicle” used in this description indicates a general transportation means the state of which is notified to the user to provide convenience to the user. Note that, in the drawings, identical reference symbols are given to components having identical functions.

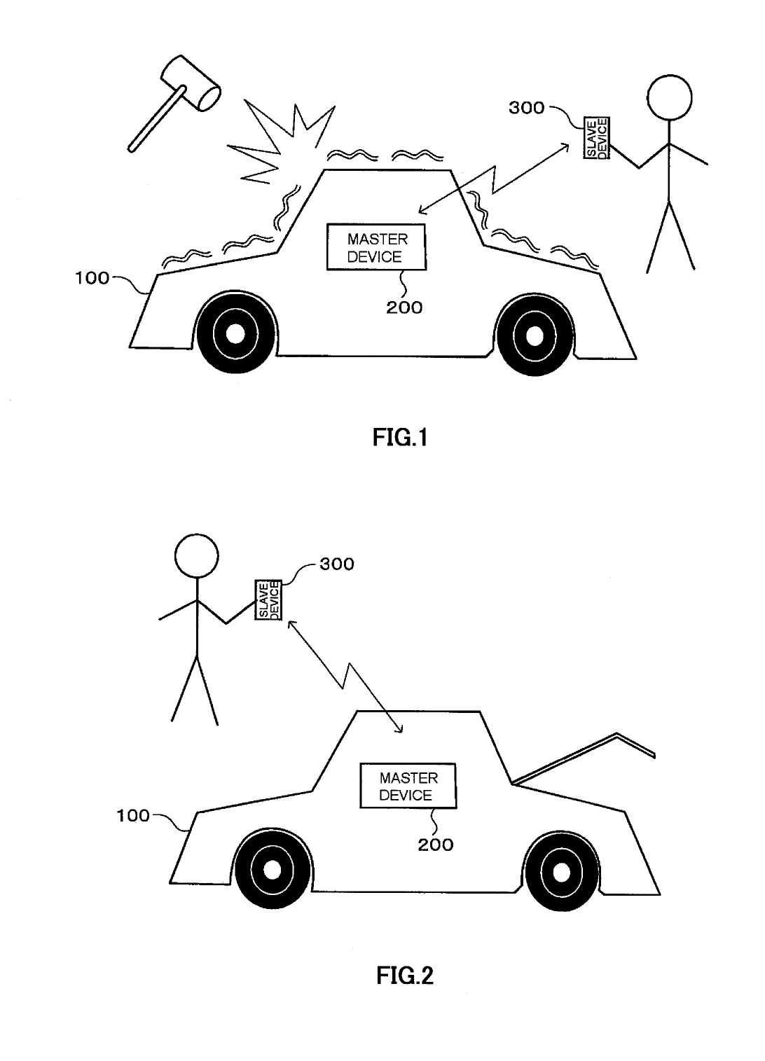

FIG. 1 is a diagram showing a configuration example of a notifying system according to this embodiment. The notifying system is configured by including a master device 200 provided for an automobile 100 of a user and a slave device 300 carried by the user. The master device 200 and the slave device 300 include, a weak-power radio module which allows bidirectional communication and requires no license under the Radio Law as a main component.

First, a description is given of an outline operation of the notifying system.

(From Automobile to User)

FIG. 1 shows an example in which an abnormality occurs in the automobile 100 because of a car break-in and the master device 200 notifies the slave device 300 of the occurrence of the abnormality.

The master device 200 can send, to the slave device, notification data indicating the state of the automobile 100, which includes the locking state of doors and windows and the lightning state of an interior light. In FIG. 1, upon occurrence of an act of vandalism to the automobile 100 by a thief, the master device 200 detects an incident which is highly probably caused by the act of vandalism, such as an abnormal vibration of the automobile caused by the act of vandalism, by a vibration sensor or the like, and notifies the slave device 300 that an abnormality occurs in the automobile 100 by using the notification data. When notified of the abnormality by the notification data sent from the master device 200, the slave device 300 notifies the user that the master device 200 has detected the abnormality, by generating a warning sound, for example.

As described above, in the example of FIG. 1, since communication can be made from the master device 200 to the slave device 300, it is possible to notify the user that the master device 200 has detected the occurrence of an abnormality in the automobile 100 of the user, caused by a car break-in.

(From User to Automobile)

FIG. 2 shows an example in which the user voluntarily confirms whether an abnormality occurs in the automobile 100. In this case, the user uses the slave device 300 carried by the user to send a signal requesting to notify of the state of the automobile 100, that is, transmission request data, to the master device 200.

Upon reception of the transmission request data from the slave device 300, the master device 200 sends notification data indicating the current state of the automobile 100 to the slave device 300. Accordingly, the user at the outside of the automobile can check the state of the automobile, for example, whether a trunk lid of the automobile 100 is opened or not.

A description is given of configuration examples of the master device 200 and the slave device 300, which allow notification of the state of the automobile as shown in FIGS. 1 and 2.

(Configurations of Master Device and Peripheral Devices)

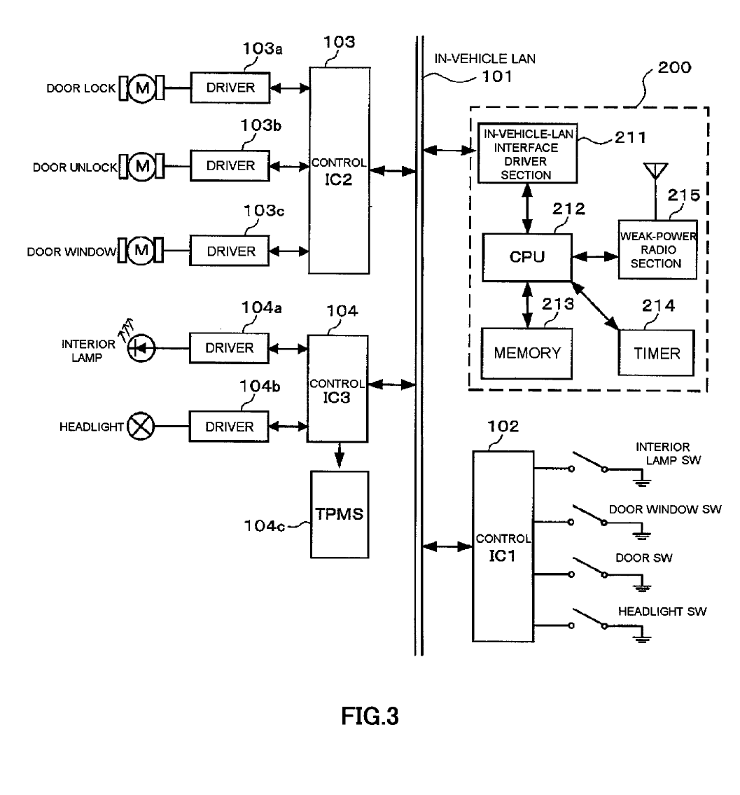

The master device 200 operates in cooperation with peripheral devices provided for the automobile. FIG. 3 shows examples of peripheral devices included in the automobile 100 and the functional relationship between those peripheral devices and the master device 200.

In this embodiment, a description is given on the assumption that an in-vehicle LAN (LAN is an abbreviation of local area network, and is used hereinafter) 101 is provided for the automobile 100. The in-vehicle LAN 101 is connected to a control IC (IC is an abbreviation of integrated circuit and is used hereinafter) 102, a control IC 103, and a control IC 104. The master device 200 is also connected to the in-vehicle LAN 101.

The master device 200 is provided with an in-vehicle-LAN interface driver section 211, a CPU 212, a memory 213, a timer 214, and a weak-power radio section 215. The master device 200 is connected to the control ICs 102 to 104 through the in-vehicle-LAN interface driver section 211 and the in-vehicle LAN 101. The CPU 212 executes a predetermined program so as to operate as a control means which performs various control processings for notifying the slave device 300 of the state of the vehicle. In this embodiment, the CPU 212 generates notification data having a format which can be exchanged with the slave device 300, based on data obtained from the control IC 103, 104, and performs a series of control processings to send the notification data to the slave device 300 through the weak-power radio section 215. Details of the control processings will be described later.

In this embodiment, the in-vehicle LAN 101, the control IC 102, and the like are all included in the automobile 100 in advance, and the master device 200 is connected to the in-vehicle LAN 101 afterward. However, for existing automobiles which do not include all or a part of the in-vehicle LAN 101, the control IC 101, and the like, the master device 200 needs to have functions equivalent to the control ICs 102 to 104 in advance.

The timer 214 measures receiving intervals of signals sent from the slave device 200 in order to synchronize intermittent communication with the slave device 200.

Each of the control ICs 102 to 104 operates as follows, for example.

The control IC 102 is connected to each of various sensors, such as a door switch, a door window switch, an interior lamp switch, a headlight switch, and a vibration sensor (not shown), which have already been provided for the automobile 100 and sends a detection result obtained from each of the switches and the like to the master device 200 through the in-vehicle LAN 101. When an input is received from each of the door switch and the door window switch, the control IC 102 sends data corresponding to the input to the control IC 103 through the in-vehicle LAN 101. When an input is received from each of the interior lamp switch and the headlight switch, the control IC 102 sends data corresponding to the input to the control IC 104 through the in-vehicle LAN 101.

The control IC 103 monitors and controls the doors and the door windows. Specifically, when the doors are unlocked, the control IC 103 controls a door lock mechanism through a driver 103a to allow the doors to be locked. When the doors are locked, the control IC 103 controls a door unlock mechanism through a driver 103b to allow the doors to be unlocked. Further, the control IC 103 controls a door window opening/closing mechanism through a driver 103c to allow the doors to be opened or closed.

Further, the control IC 103 notifies the master device 200 and the other devices connected through the in-vehicle LAN 101, of the current door lock state and door window opening/closing state, and the presence or absence of vibration applied to the automobile. More specifically, the control IC 103 stores data indicating the state of the doors and the door windows, which are targets to be monitored and controlled, such as data indicating the door lock state and the door window opening/closing state, in a memory (not shown) in advance. In response to a request of the control IC 102, the master device 200, or the like, the control IC 103 sends data stored in the memory to the request source. Since the control IC 103 is connected to a vibration sensor, vibration of the automobile 100 can be detected and data indicating the state of the vibration and detection history can be stored.

The control IC 104 performs on/off control for the headlights and other control through a driver 104b. The control IC 104 is also connected to a tire pressure monitoring system (TPMS) 104c which detects the air pressure in tires which are also targets to be monitored. The control IC 104 detects various states of the automobile, which include the on/off states of the interior lamp and the headlights, according to data sent from the control IC 102, and also controls the headlights and the like.

The control IC 104 can notify the master device 200 and the like of the on/off states of the interior lamp and the headlights and information on the tire pressure. More specifically, the control IC 104 is configured to store, in the memory (not shown), the state of the interior lamp, the state of the headlights, and the state of the tires, i.e., the air pressure of the tires in this embodiment, and to notify of those states in response to a request sent from the other ICs or the master device 200.

The CPU 212 of the master device 200 performs control processing as follows, for example.

First, the CPU 212 obtains data indicating the states of the doors, the door windows, the interior lamp, and the headlights from the control IC 103, 104, provided for the automobile 100, through the in-vehicle-LAN interface driver section 211. At this time, the CPU 212 synchronizes intermittent communication with the slave device 300 based on the receiving interval measured by the timer 214, and obtains the above-mentioned data from the control IC 103, 104 upon reception of a request sent from, for example, the slave device 300. The CPU 212 generates, from the obtained data, notification data having a data structure (format) which can indicate the state of the automobile 100 and can be communicated with the slave device 300. The CPU 212 controls the weak-power radio section 215 to send the notification data to the slave device 300. As a result of the above-mentioned control processing performed by the CPU 212, data indicating the state of the doors and the like obtained by the CPU 212 is stored in the memory 213.

(Internal Configuration of Slave Device)

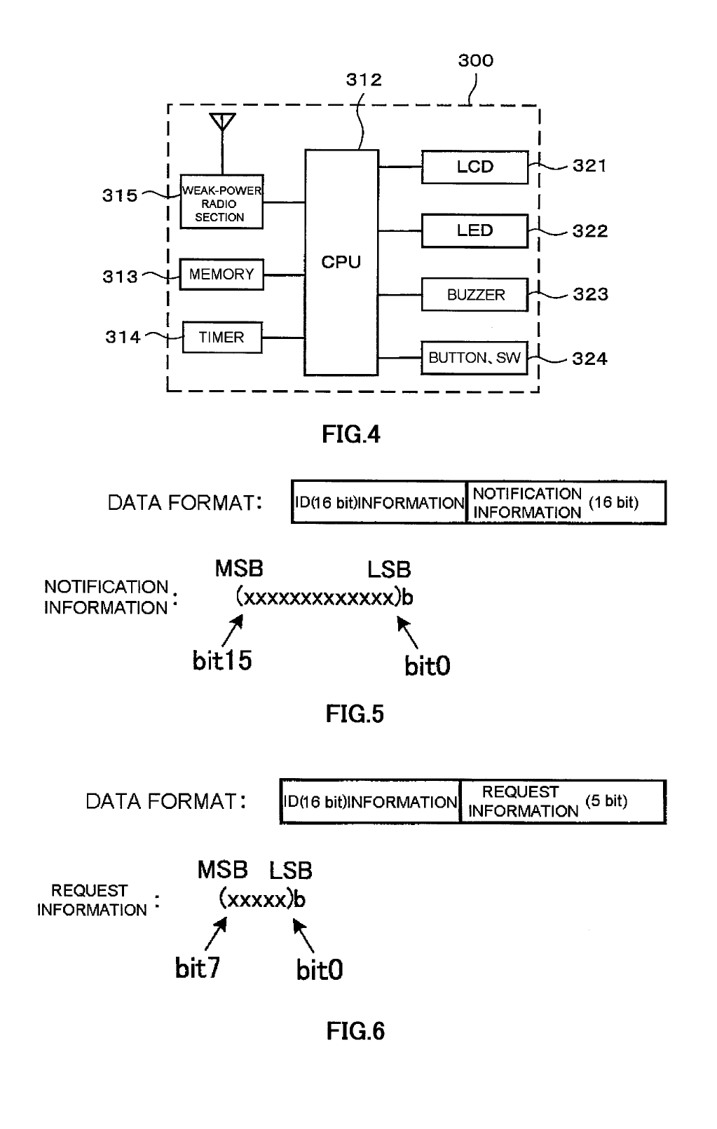

Next, an example internal configuration of the slave device 300 will be described with reference to FIG. 4.

In FIG. 4, the slave device 300 is provided with a CPU 312 operating according to a predetermined program. The CPU 312 performs bidirectional communication with the master device 200 through a weak-power radio section 315, and also performs various processings related to data obtained from the master device 200 through the weak-power radio section 315. The data obtained from the master device 200 and a result of the data processing are recorded in a memory 313 connected to the CPU 312. The CPU 312 is also connected to a timer 314. The timer 314 determines timing for outputting a signal such that signal output is performed at predetermined intervals in order to synchronize the communication with the master device 200. The CPU 312 controls the weak-power radio section 315 by using a signal outputted from the timer 314 so as to perform intermittent communication with the master device 200. The CPU 312 is also connected to an LCD 321 and an LED 322 through predetermined interfaces so as to notify the user of the state of the automobile 100.

Each of the LCD 321 and the LED 322 is one of visualization means and is configured to display information on the opening/closing state of the doors or the windows and the on/off state of a power supply of the slave device 300. The CPU 312 is also connected to a buzzer 323 through a predetermined interface. In a case of the occurrence of an abnormality, e.g., in a case in which it has been detected that the automobile 100 is damaged by a thief breaking thereinto, it is possible to generate a buzzer sound to notify the user that an abnormality has occurred. The CPU 312 is further connected, through a predetermined interface, to input buttons and switches serving as an input section to accept an instruction, e.g., an instruction to activate the slave device 300, inputted by the user.

The master device 200 and the slave device 300, which are configured as described above, can perform bidirectional intermittent communication. Therefore, it is possible not only to perform communication from the slave device 300 to the master device 200 to realize a remote key function, such as door opening and remote engine start, but also to voluntarily perform communication from the master device 200 to the slave device 300, upon detection of vibration caused by an abnormal event such as a car break-in, to notify of the occurrence of an abnormality.

(Operation Example of Notifying System)

Hereinafter, a specific description is given of an operation example performed when the user is notified of the state of the automobile 100 through the cooperation of the master device 200 and the slave device 300 shown in FIGS. 3 and 4.

Between the master device 200 and the slave device 300, establishment of synchronization of intermittent communication and established-synchronization maintaining operation are performed for the purpose of position confirmation and the like. In this embodiment, the synchronization establishment and the maintaining operation are performed periodically. When synchronization of the intermittent communication cannot be maintained because of a change in position of the slave device 300 and the slave device 300 is out of the communication area, the slave device 300 notifies the user of being out of the communication area using the LCD 321 or the LED 322.

The master device 200 sends notification data indicating the current state of the automobile 100 to the slave device 300. FIG. 5 shows an example format of the notification data.

As shown in the figure, the notification data sent from the master device 200 to the slave device 300 is composed of 16 bits of ID information and 16 bits of automobile state information. The ID information is used by the slave device 300 to uniquely identify notification data obtained from the master device 200. The automobile state information has 16 bits from bit 0 to bit 15 in this embodiment, but the number of bits can be desirably specified corresponding to the type of information to be notified to the user and can be varied afterward. An event is assigned to each bit. When the bit whose value is logical “1” indicates that the corresponding event has occurred. The bit whose value is logical “0” indicates that corresponding event has not occurred.

Specifically, in the automobile state information, bit 0 corresponds to an event of “vibration occurring in automobile”, bit 1 corresponds to an event of “the hood opening/closing”, bit 2 corresponds to an event of “the driver door opening/closing”, bit 3 corresponds to an event of “the passenger door opening/closing”, bit 4 corresponds to an event of “the driver side rear door opening/closing”, bit 5 corresponds to an event of “the passenger side rear door opening/closing”, bit 6 corresponds to an event of “the trunk lid opening/closing”, bit 7 corresponds to an event of “the engine starting”, bit 8 corresponds to an event of “a reduction in tire air pressure”, bit 9 corresponds to an event of “the driver door window opening/closing”, bit 10 corresponds to an event of “the passenger door window opening/closing”, bit 11 corresponds to an event of “the driver side rear door window opening/closing”, bit 12 corresponds to an event of “the passenger side rear door window opening/closing”, bit 13 corresponds to an event of “the headlights on”, bit 14 corresponds to an event of “the interior lamp on”, and bit 15 corresponds to an event of “the door lock being released”. Therefore, when the value of bit 0 is 1, vibration has occurred in the automobile 100. In the slave device 300, when the value of bit 0 of notification data sent from the master device 200 is 1, it is possible to notify that vibration has occurred to the automobile 100 and a car break-in or the like may have occurred in the automobile 100, by performing predetermined display on the LCD 321 or the LED 322 or by generating a warning buzzer sound with the buzzer 323.

FIG. 6 shows an example format of transmission request data sent from the slave device 300 to the master device 200. As shown in the figure, the transmission request data is composed of 16 bits of ID information and 5 bits of a request content. The ID information is used by the master device 200 to uniquely identify data sent from the individual slave device 300. The request content is composed of 5 bits from bit 0 to bit 4. However, the number of bits can be desirably specified corresponding to the type of information to be notified by the user and can be varied afterward (however, to change the number of bits, coordination with the master device 200 is necessary). An event is assigned to each bit. The bit whose value is 1 indicates that the occurrence of the corresponding event is requested. The bit whose value is 0 indicates that the occurrence of the corresponding event is not requested.

Specifically, in the request content, bit 0 corresponds to “a request for central door lock”, bit 1 corresponds to “a request for central door lock release (unlock)”, bit 2 corresponds to “a request for remote engine start”, bit 3 corresponds to “a request for remote engine stop”, and bit 4 corresponds to “a request for automobile state confirmation”.

The notification of the state of the automobile is accompanied by both communication from the master device 200 to the slave device 300 and communication from the slave device 300 to the master device 200.

Through the communication from the master device 200 to the slave device 300, the master device 200, provided for the automobile, voluntarily sends notification data to the slave device 300, carried by the user, according to a detected result indicating the state of the automobile 100. In this case, the slave device 300 notifies the user of the state of the automobile 100 through the LED 321, the LCD 322, or the buzzer 323. On the other hand, through communication from the slave device 300 to the master device 200, the slave device 300, carried by the user, sends transmission request data to the master device 200. In response to the transmission request data, the master device 200 controls locking of the doors of the automobile 100 or opening/closing of the windows thereof, or sends data indicating the state of the automobile 100 to the slave device 300.

In this embodiment, in both cases, communication is intermittently performed between the master device 200 and the slave device 300.

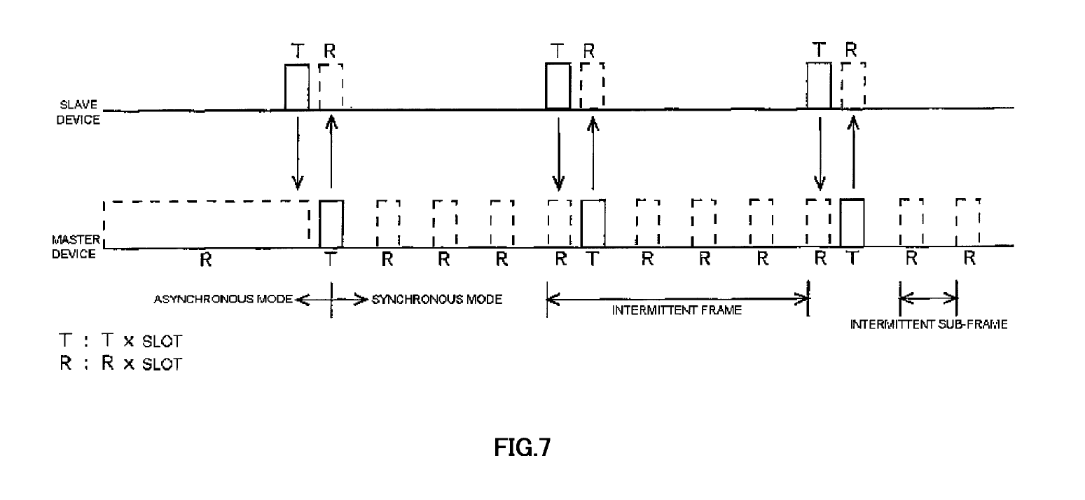

FIG. 7 is an explanatory diagram of timing of communication performed between the master device 200 and the slave device 300, which sends the transmission request data shown in FIG. 6. In this figure, during an asynchronous mode in which communication synchronization is not established between the master device 200 and the slave device 300, the master device 200 is in a continuous reception mode (indicated by “R” in this figure) where the master device 200 waits to receive data sent from the slave device 300. At a first transmission and reception time indicated by “T1”, the slave device 300 becomes a transmission mode (indicated by “T” in the figure) in an asynchronous mode as indicated by the leftmost downward arrow in FIG. 7. Specifically, the slave device 300 sends transmission request data that includes its own ID information and the request content shown in FIG. 6 in a predetermined format to the master device 200. The master device 200, which is in a standby mode, receives the transmission request data sent from the slave device 300, and performs authentication based on the ID information included therein.

The slave device 300 becomes a standby mode after sending the transmission request data. On the other hand, after receiving the transmission request data from the slave device 300, the master device 200 sends notification data to the slave device 300 (transmission mode) under the condition that the authentication has been normally performed. Specifically, the master device 200 sends notification data that includes its own ID information and the automobile state information shown in FIG. 6 in the predetermined format to the slave device 300, and then, becomes an intermittent reception mode. The slave device 300, which is in the standby mode, receives the detection data, performs authentication based on the ID information included therein, and obtains the automobile state information under the condition that the authentication has been normally performed. After that, the slave device 300 becomes an intermittent transmission mode.

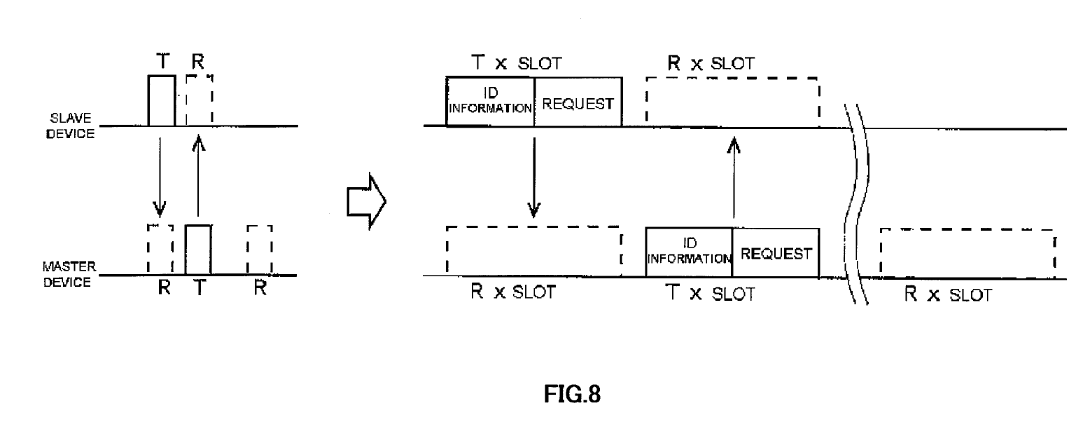

FIG. 8 shows communication performed at intermittent timing between the master device 200 and the slave device 300. Specifically, the slave device 300 sends transmission request data to the master device 200 in the transmission mode (indicated by “Tx slot” in FIG. 8). The master device 200 receives the notification data sent from the slave device 300 in the reception mode (indicated by “Rx slot” in FIG. 8), detects the state of the automobile 100, generates notification data that includes the detected result serving as automobile state information, and its ID information, and sends the notification data to the slave device 300 (the master device 200 becomes the transmission mode). Note that when transmission request data is not received from the slave device 300 during the reception mode, the master device 200 does not become the transmission mode but maintains the standby mode as it is.

As described above, when authentication is mutually performed based on ID information between the master device 200 and the slave device 300, and the authentication is normally performed, communication synchronization is established there between. After that, the master device 200 and the slave device 300 perform intermittent reception and transmission operations.

In the intermittent transmission and reception operations, the master device 200 and the slave device 300 mutually try to maintain the synchronization by sending and receiving mutual ID information and transmission request data or notification data at predetermined intermittent timing. The master device 200 sequentially performs notification of the automobile state.

Since the automobile state is not frequently changed in general, the length of an intermittent transmission and reception interval (first interval) may be set longer, for example, about several seconds to several tens of seconds in order to reduce power consumption.

A reception operation interval of the master device 200 and that of the slave device 300 may be identical to each other. In this case, however, it is expected that convenience of the user is reduced in the above-mentioned case where the intermittent transmission and reception interval is too long. For example, a case may be occurred in which the user cannot have the doors of the automobile 100 locked or unlocked at a desired point of time.

For this reason, in this embodiment, a reception operation interval of the master device 200 is set to 0.5 seconds per one frame such that data can be received at intervals of 0.5 seconds (second interval). On the other hand, after establishment of communication synchronization with the master device 200, a reception operation interval of the slave device 300 is set to 2 seconds, which means every four frames, in the usual operation. In a special operation caused by an instruction inputted by the user at a desired point of time, the reception operation interval of the slave device 300 is set to 0.5 seconds. In this case, the slave device operates at intervals of 0.5 seconds in a period between transmission of transmission request data to the master device 200 and reception of notification data responding to the transmission request data from the master device 200. Accordingly, while reducing power consumption in the usual operation, it is possible to cope flexibly with an instruction (e.g., an instruction to lock or unlock the doors of the automobile 100) inputted by the user at a desired point of time.

FIG. 8 shows that data is sent from the slave device 300 when the master device 200 is in the reception mode, and upon reception of the data, the master device 200 immediately sends notification data to the slave device 300 in response.

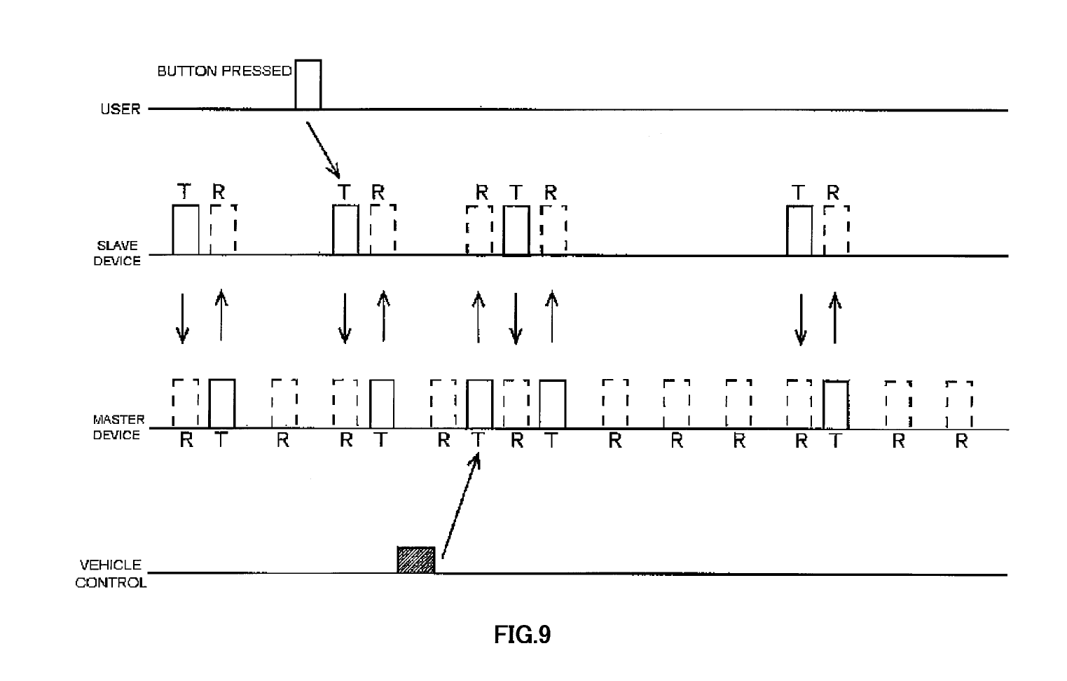

FIG. 9 shows an operation state of the slave device 300 performed when an instruction is inputted by the user to the slave device 300. The slave device 300 sends transmission request data in the first frame after the instruction inputted by the user. The master device 200 receives the transmission request data from the slave device 300, performs automobile control, such as locking/unlocking of the doors of the automobile 100, if necessary according to the transmission request data, and sends notification data to the slave device 300 if necessary to notify the slave device 300 of the state of the door windows or the lights. The master device 200 sends the notification data to the slave device 300 in the first frame after the automobile control. In this embodiment, as shown in FIG. 9, the automobile control is completed within one frame, and the notification data is sent in the frame immediately after (0.5 seconds after) the frame in which the transmission request data is received from the slave device 300. With this configuration allowing such an operation, while the slave device 300 performs transmission and reception with the master device 200 at intervals of 2 seconds in the usual operation, the slave device 300 can perform transmission and reception with the master device 200 within 0.5 seconds in the special operation caused by an instruction inputted by the user.

Further, in this embodiment, in order that, upon reception of transmission request data from the slave device 300, the master device 200 can immediately notify the slave device 300 of the state of the automobile 100, the master device 200 periodically obtains data (hereinafter, referred to as “status”) indicating the state of the automobile 100 and sends notification data indicating the latest state of the automobile 100 to the slave device 200 at the time of communication with the slave device 300. In this case, it is preferable that the master device 200 (CPU 212) request the control IC 103, 104 to send the status of the doors, the interior lamp, or the like, and each status be detected and stored in advance, while transmission or reception of data is not performed between the master device 200 and the slave device 300.

The master device 200 periodically detects the state of the automobile 100 in addition to performing an operation corresponding to transmission request data sent from the slave device 300. When the state of the automobile 100 has changed, the master device 200 notifies the slave device 300 about the change by sending notification data in the first frame after the state has been confirmed.

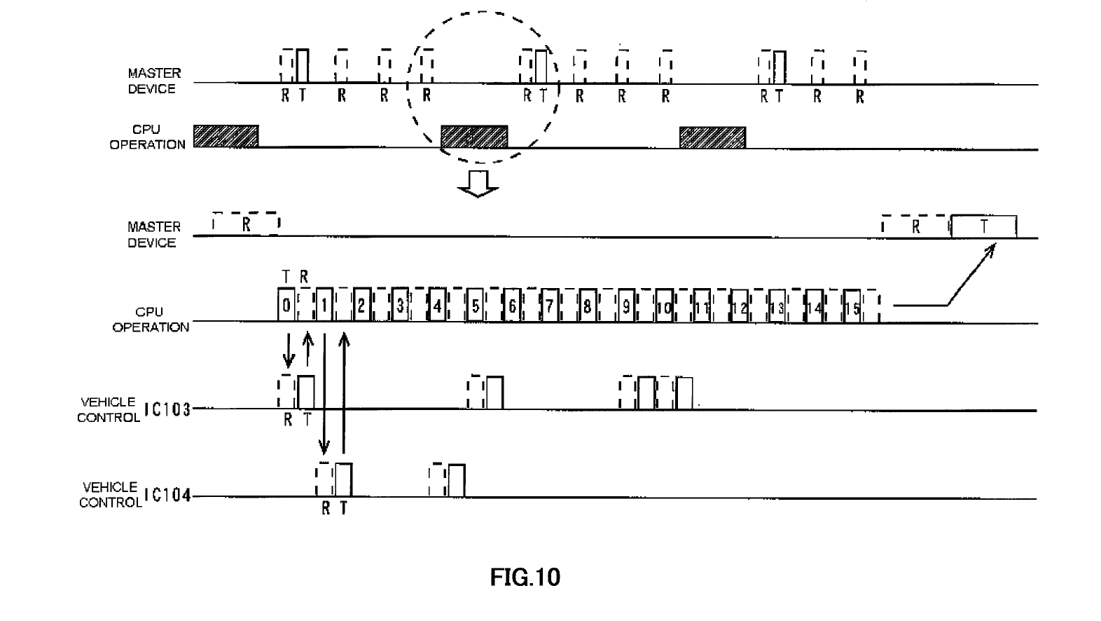

FIG. 10 is an explanatory diagram of timing of a state confirmation operation performed by the master device 200. As shown in the figure, in the master device 200, the CPU 212 exchanges data with the control ICs 102 to 104 through the in-vehicle-LAN interface driver section 211 and the in-vehicle LAN 101, between a frame and the next frame which are used for the slave device 300. Specifically, the CPU 212 sequentially sends a request to the control IC corresponding to each event indicated by bit 0 to bit 15 of FIG. 5 and receives the status from the control IC.

For example, to know the status of an event of “vibration occurred” indicated by bit 0 of notification data, the CPU 212 sends, through the in-vehicle LAN 101, a request to the control IC 103 to send the status and receives the status related to vibration from the control IC 103. In the same way, for an event of “the hood opening/closing” indicated by bit 1, the CPU 212 also sends a request to the control IC 103 and receives the status.

In this way, the CPU 212 sequentially receives the status of each event corresponding to bit 0 to bit 15 of notification data, from the control IC 103 or the control IC 104. The CPU 212 generates notification data based on the thus received status and sends the notification data to the slave device 300 at the time of next communication with the slave device 300, thereby notifying the slave device 300 of the status of the automobile 100.

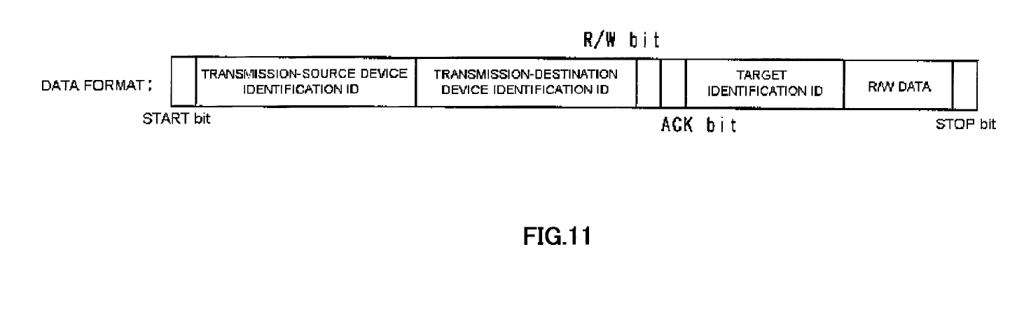

FIG. 11 shows an example format of data (internal communication data) exchanged between the CPU 212 of the master device 200 and the control IC 103, 104. The internal communication data includes, starting from the head of the data, a start bit, a transmission-source device identification ID, a transmission-destination device identification ID, an R/W bit, an ACK bit, a target identification ID, R/W data, and a stop bit.

The start bit is used to identify a start point of data to be exchanged. The transmission-source device identification ID and the transmission-destination device identification ID are each assigned to a device such as the CPU 212 and the control IC 102, and therefore used to identify a transmission-source device and a transmission-destination device, respectively. In the example, the CPU 212 corresponds to a transmission-source device and the control IC 103, 104 corresponds to a transmission-destination device. For example, a value of “0000” is assigned to the CPU 212, a value of “0001” is assigned to the control IC 103, and a value of “0002” is assigned to the control IC 104.

The R/W bit is an identification bit used for status confirmation and control request. In this embodiment, the R/W bit is set to “0” to confirm the status and is set to “1” to request to perform target control such as locking/unlocking of the doors.

The ACK bit is used to confirm whether the last data has been normally received. For example, the ACK bit is set to “1” when the data has been normally received, and is set to “0” when the data has not been normally received.

The target identification ID is used to identify, when one control IC has multiple control target components, each of the control target components. In this embodiment, since the control IC 104 controls the interior lamp and the headlights, an identification ID is assigned to the interior lamp and to the headlights.

The R/W data indicates control request data for a control target when the R/W bit is set to “1”. The control target request data is sent from the CPU 212 to the control IC 103 or the control IC 104. In this embodiment, the R/W data is set to have 5 bits. For example, when the CPU 212 requests the door lock mechanism to lock the doors, the R/W data is set to have a value of 0001. To maintain the current door lock state, the R/W data is set to have a value of “0001”. On the other hand, when the R/W bit is set to “0”, the R/W data indicates status response data used to return the status from the control IC 103, 104 to the CPU 212. For example, when the interior lamp of the automobile 100 is on, the R/W data has a value of “0000”. When the interior lamp thereof is off, the R/W data has a value of “0001”.

The stop bit is used to identify an end point of data to be exchanged.

By exchanging internal communication data having such a format between the CPU 212 of the master device 200 and the control IC 103, 104, the CPU 212 can request the control IC 103, 104 to send the status of the doors or the interior lamp of the automobile 100, and the control IC 103, 104 can send the status to the CPU 212.

Next, a description is given of control processing operations performed by the CPU 212 of the master device 200 and the CPU 312 of the slave device 300.

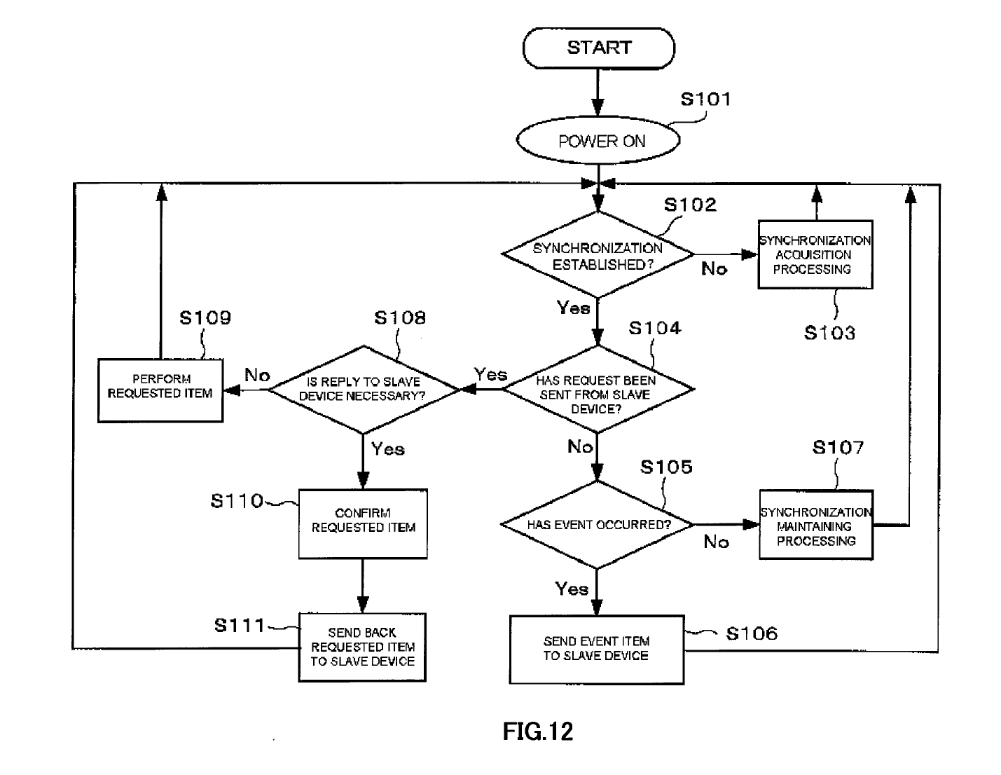

FIG. 12 is a diagram showing an operation procedure of the CPU 212.

Upon detection of a power-on state of the master device 200 (S101), the CPU 212 determines whether synchronization with the slave device 300 has been established (S102). When synchronization has not been established (No in S102), the CPU 212 performs synchronization acquisition processing to establish synchronization with the slave device 300 (S103). In the synchronization acquisition processing, the CPU 212 becomes the standby mode as shown in FIG. 7, and establishes synchronization (acquires synchronization) with the slave device 300 when transmission request data is sent from the slave device 300. After the synchronization acquisition processing, the operation of the CPU 212 returns to Step S102, and it is determined again whether synchronization with the slave device 300 has been established.

When it is determined in Step S102 that synchronization has been established (Yes in S102), the CPU 212 determines whether transmission request data has been sent from the slave device 300 (S104). When transmission request data has not been sent (No in S104), the CPU 212 determines whether an event has occurred (S105). In this determination processing, the CPU 212 performs a state confirmation operation of the automobile 100 as shown in FIG. 10, and compares its operation result with the last time operation result. As a result of the comparison, when the state has changed (Yes in S105), the CPU 212 determines that an event (fact that the state of the automobile has changed) has occurred and sends the changed state content to the slave device 300 as an event item (S106). Then, the operation of the CPU 212 returns to Step S102.

When the state has not changed (No in S105), the CPU 212 maintains the synchronization as it is (S107). Then, the operation of the CPU 212 returns to Step S102.

Through the above-described operation of the CPU 212, when an abnormal vibration is generated in the automobile 100 or a door closed by the user is opened because of an abnormal event, such as a car break-in, occurred in the automobile 100, the state of the automobile 100 changes. In this case, a result of the determination of Step S105 shows “Yes” and the slave device 300 is notified of the changed status content.

The slave device 300 notifies the user that the state of the automobile 100 has changed by a desired method using, for example, screen display, a warning lamp, a warning sound, or vibration of the slave device 300 itself. In this way, the master device 200 can notify the user of the state of the automobile 100 through the slave device 300.

On the other hand, when it is determined in Step S104 that transmission request data has been sent from the slave device 300, the CPU 212 detects each value of bit 1 to bit 4 of the format, shown in FIG. 6, of this transmission request data, and determines whether it is necessary to reply to the slave device 300 (S110). In this embodiment, it is necessary to reply to the slave device 300 only when the value of bit 4 is “1”. Therefore, the CPU 212 determines whether the value of bit 4 of request information of the transmission request data is “1” or “0”. When the value of bit 4 is “0”, the CPU 212 determines that it is not necessary to reply to the slave device 300 (No in S108) and controls the automobile 100 according to the request information of the values of bit 0 to bit 3 (S109). Then, the operation of the CPU 212 returns to Step S102.

When it is determined that a reply to the slave device 300 is necessary (Yes in S108), the CPU 212 performs control according to the request information, receives the status of the door lock or the like from the control IC 103, 104 (S110), and sends notification data to the slave device 300. Then, the operation of the CPU 212 returns to Step S102.

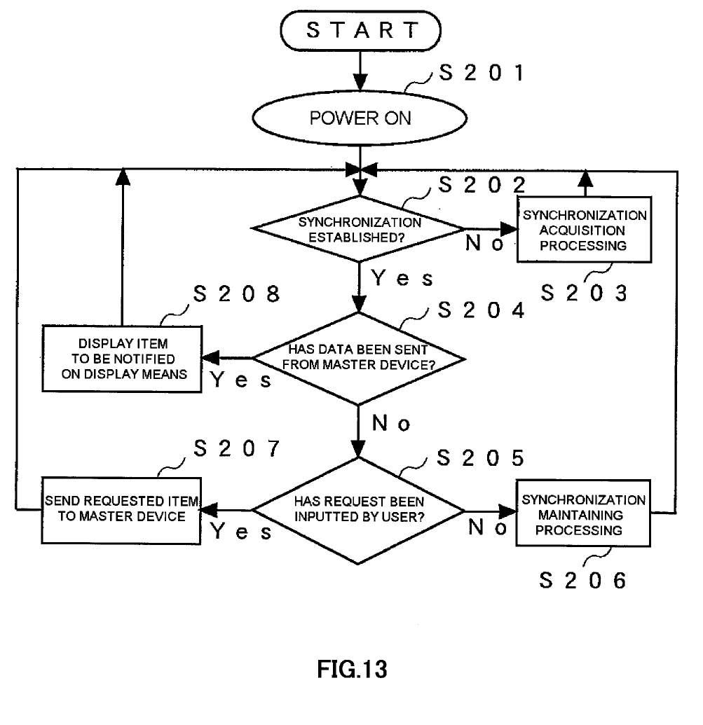

FIG. 13 is a diagram showing an operation procedure of the CPU 312 of the slave device 300.

Upon detection of a power-on state of the slave device 300 (S201), the CPU 312 determines whether synchronization with the master device 200 has been established (S202). When synchronization has not been established (No in S202), the CPU 312 performs synchronization acquisition processing to establish communication synchronization with the master device 200 (S303). In the synchronization acquisition processing, the slave device 300 sends transmission request data to the master device 200 as shown in FIG. 7, and acquires synchronization with the master device 200 when notification data is sent from the master device 200. After the synchronization acquisition processing, the operation of the CPU 312 returns to Step S202, and it is determined again whether synchronization with the master device 200 has been established.

When it is determined in Step S202 that synchronization has been established (Yes in S202), the CPU 312 determines whether notification data has been sent from the master device 200 (S204). When notification data has not been sent (No in S204), the CPU 312 determines whether an instruction has been inputted by the user, in other words, whether transmission request data has been requested (S205). When transmission request data has not been requested (No in S205), the CPU 312 maintains the synchronization as it is.

When an instruction has been inputted by the user, the CPU 312 sends transmission request data to the master device 200 (S207). On the other hand, when notification data has been sent from the master device 200 (Yes in S204), the CPU 312 notifies the user of the state of the automobile 100 obtained from the master device 200, by displaying the content of the notification data on a display or the LED of the slave device 300 or by generating a warning buzzer sound. Then, the operation of the CPU 312 returns to Step S202.

As described above, in the notification system of this embodiment, since the master device 200 detects the state of the automobile 100 and notifies, when the state of the automobile 100 has changed, the user of the changed state content through the slave device 300, it is possible to enhance the security of the automobile 100 through cooperation of the master device 200 and the slave device 300. Notification data includes data indicating events such as vibration of the automobile 100, starting of the engine, and opening/closing of the doors. In general, those events hardly occur when the user is far from the automobile 100. If any of those events has occurred, the automobile 100 may be subjected to some abnormal events or risks because of a car break-in or the like.

(Exterior Appearance and Configuration of Slave Device)

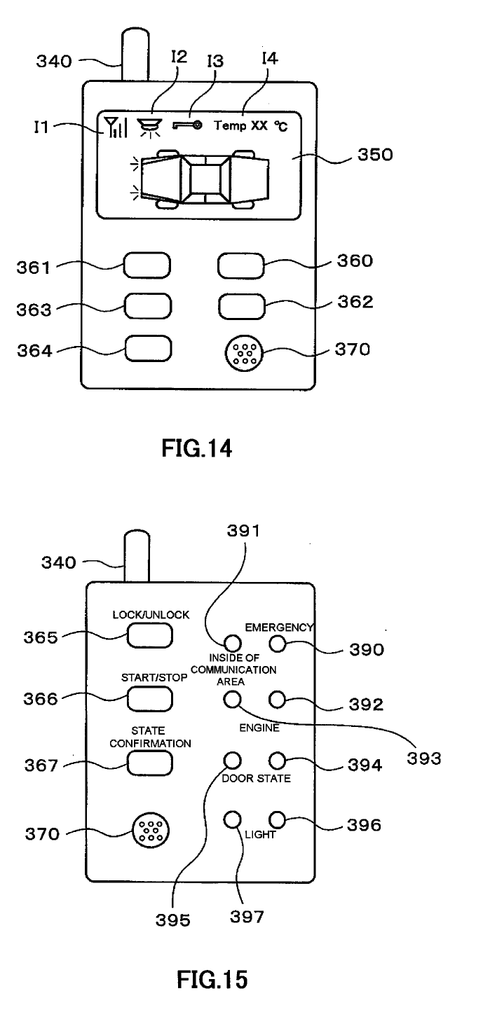

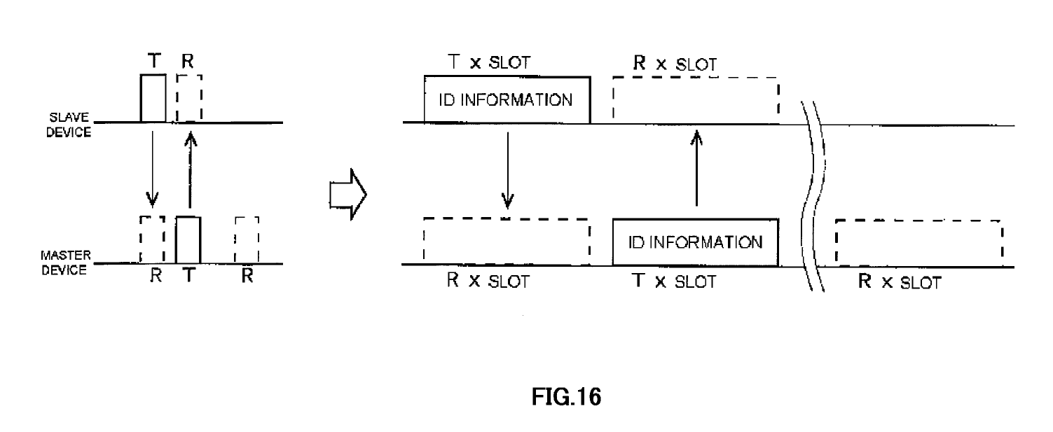

The slave device 300 can be accommodated in various types of housings and implemented. FIG. 14 shows an example exterior configuration of a housing of the slave device 300. The housing of the slave device 300 shown in FIG. 14 is provided with an antenna 340, a display 350, a central door lock button 360, a central door unlock button 361, a remote engine start button 362, a remote engine stop button 363, a vehicle state confirmation button 364, and a speaker 370.

The antenna 340 is connected to the weak-power radio section 315 of the slave device 300 shown in FIG. 4. Bidirectional communication using weak-power radio can be performed with the master device 200 through the antenna 340. The display 350 displays icons I1, I2, I3, and I4. The icons I1, I2, I3, and I4 indicate the communication radio field intensity, the on/off state of the interior lamp, the lock state of the doors, and the temperature, respectively. The display 350 also displays an outline view of the automobile 100. When an event of opening/closing of the trunk lid or the passenger door has occurred in the automobile 100, the corresponding portion is highlighted in the outline view. For example, when bit 9, which corresponds to “the driver door window is opening/closing”, of the state notification data shown in FIG. 5 is “1”, the portion of the driver door window is highlighted in the outline view of the automobile. A known technique can be used for such display processing.

The central door lock button 360, the central door unlock button 361, the remote engine start button 362, the remote engine stop button 363, and the vehicle state confirmation button 364 are pushed by the user to notify the CPU 315 of the corresponding instruction. Specifically, the remote engine start button 362 and the remote engine stop button 363 are used to externally cause the master device 200 to start and to stop the engine of the automobile 100, respectively. The vehicle state confirmation button 364 causes the master device 200 to perform notification of the current state of the automobile 100.

The speaker 370 is used to notify the user that the status of the automobile 100 has changed, and it notifies the user of the change of the status by a buzzer sound or warning voice, for example.

In order to reduce power consumption of the slave device 300, the slave device 300 may have an exterior as shown in FIG. 15. In this example, a button 365 serves as both the central door lock button 360 and the central door unlock button 361 described above. When the button 365 is pushed once, the doors are locked, and when the button 365 is pushed twice, the doors are unlocked. Similarly, a button 366 serves as both the remote engine start button 362 and the remote engine stop button 363 described above. Further, the display 350 is omitted, and LEDs 390 to 398 are provided instead.

The LED 390 is used to indicate an emergency state. For example, when it is determined from notification data sent from the master device 200 that multiple events, such as “vibration occurring” and “the trunk lid opening/closing”, have occurred and the automobile 100 may be subjected to a car break-in, the LED 390 is turned on in red, for example, and a buzzer sound is generated from the speaker 370. In detecting an emergency state, the CPU 312 of the slave device 300, shown in FIG. 4, detects the value of each bit of notification data sent from the master device 200. When a predetermined condition to determine that the automobile 100 has been subjected to a car break-in is satisfied, an emergency state is determined. The predetermined condition can be desirably set, for example, to a condition where “among statuses detected in the automobile 100, a predetermined number of statuses or more, e.g., two statuses or more, have changed”, or to a condition where “a specific status has changed, e.g., tire air pressure has been reduced (corresponding to bit 8 shown in FIG. 4)”.

The LED 391 indicates whether the slave device 300 is located inside or outside of the communication area. The LED 391 glows green, for example, when the slave device 300 is inside of the communication area, and turns off when the slave device 300 is outside of the communication area. The LED 392, 393 indicates the state of the engine. While the engine is stopped, the LED 392 glows green. While the engine is operating, the LED 393 glows red. The LED 394, 395 indicates the state of the doors. When the doors are closed, the LED 394 glows green. When the doors are opening/closing, the LED 395 glows red. The LED 396, 397 indicates the state of the headlights. When the headlights are off, the LED 396 glows green. When the headlights are on, the LED 397 glows red.

With thus configured housing of the slave device 300, it is possible, in the slave device 300, to visually notify the user of the state of the automobile 100 obtained by notification data sent from the master device 200. Further, it is possible for the user to externally cause the master device 200 to perform desired monitoring control to the automobile 100, through the various buttons 360 to 366.

(Modification)

Hereinafter, a modification of the embodiment will be described. In the above-described embodiment, when the master device 200 and the slave device 300 perform transmission and reception at intermittent timing, notification information or a request content is sent and received together with ID information, as shown in FIGS. 5 and 6. When the amount of data to be sent and received becomes larger, time required for transmission and reception becomes longer to cause an increase in power consumption, reducing the battery lifetime. Accordingly, the notifying system may be configured such that, at the time of the usual operation, notification data and transmission request data include only ID information to be sent and received; and only at the time of the occurrence of an event where the state of the automobile 100 has changed, noticed by detecting vibration generated in the automobile 100, opening/closing of the trunk lid, or the like, notification data or transmission request data is sent and received together with ID information.

On the occurrence of such an event, the CPU 212 of the master device 200 sends information indicating the occurrence of the event to the slave device 300 at a first data transmission after the event occurred. Therefore, when the state of the automobile 100 has changed because of a car break-in or the like, notification data is sent from the master device 200 to the slave device 300 together with ID information. In the slave device 300, it is possible to notify the user of the change in the state of the automobile by changing the screen display or generating a warning buzzer sound according to this change in the state.

Note that, when an instruction is inputted by the user to the slave device 300, the operation timing of the master device 200 and the operation timing of the slave device 300 are the same as those shown in FIG. 9 in the above-mentioned embodiment.

As is clear from the description given above, in the present invention, since the master device 200 and the slave device 300 perform bidirectional communication, it is possible to realize not only one-way functions such as door lock/unlock and remote engine start/stop but also remote confirmation of the state of the automobile 100 and real-time emergency notification, and to significantly enhance the convenience of the user.

Further, in this embodiment, the master device 200 is connected to the in-vehicle LAN 101. Since an interface connector of the in-vehicle LAN 101 is always provided in the automobile, it is relatively easy to connect the master device 200 to the in-vehicle LAN 101 and the user is not bothered with the introduction thereof.

Since communication performed between the master device 200 and the slave device 300 uses a weak-power radio at a frequency band which does not require a special license, there is no interference with the widespread use of the notifying system, and reduced power consumption can significantly extend the battery lifetime. Thus, the slave device 300 can be made more compact in size by using a smaller battery.

Further, since a high power is not required, a circuit configuration can be made simpler, thereby realizing cost reduction in the entire system.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents

1. A vehicle state notifying device, comprising:
a radio communication means for performing bidirectional intermittent communication with a portable terminal device by using weak power which is not restricted by a law;
a transmission request receiving means for receiving, from the portable terminal device, a transmission request to send information indicating a current state of a vehicle to be monitored, through the radio communication means;
a vehicle state detecting means for obtaining a detection result detected by a predetermined sensor, regarding the state of the vehicle corresponding to the transmission request received by the transmission request receiving means; and
a control means for controlling an operation of the radio communication means such that the radio communication means intermittently sends notification data having a predetermined data structure, indicating the detection result obtained by the vehicle state detecting means, at an interval at which the portable terminal device can receive the notification data.

2. A notifying device according to claim 1, further comprising a timer for measuring an interval of signals intermittently received from the portable terminal device,
wherein the control means controls the radio communication means such that the radio communication means establishes synchronization of intermittent communication performed with the portable terminal device based on the interval measured by the timer.

3. A notifying device according to claim 2, wherein the control means holds the interval measured after the synchronization is established, and determines whether the synchronization is maintained, by comparing the held interval with an interval measured by the timer at a later signal reception.

4. A notifying device according to claim 1, wherein the vehicle state detecting means is configured to collect the detection result from the sensor at timing not related to communication timing of the intermittent communication with the portable terminal device, to accumulate the detection result in a predetermined memory, and to read out, when the transmission request is received, the accumulated detection result regarding the vehicle state corresponding to the transmission request, from the memory.

5. A notifying device according to claim 4, wherein the vehicle state detecting means is configured to obtain the detection result from the sensor in each period, to accumulate the detection result obtained at each period in the memory, and to generate information indicating whether the vehicle state has changed, by comparing a detection result obtained at a preceding period with a detection result obtained at a current period.

6. A notifying device according to claim 5, wherein the control means controls the radio communication means such that the radio communication means obtains the information indicating whether the vehicle state has changed from the vehicle state detecting means through the intermittent communication, and, when the vehicle state has changed, sends the notification data indicating that the vehicle state has changed to the portable terminal device at timing when communication can be performed immediately after the vehicle state has changed.

7. A portable terminal device, comprising:
a radio communication means for performing bidirectional intermittent communication with a notifying device which notifies of a vehicle state in response to a request, by using weak power which is not restricted by a law;
a transmission request data generating means for generating transmission request data to request, through the radio communication means, the notifying device to send notification data indicating a current state of a vehicle to be monitored; and
a control means for controlling an operation of the radio communication means such that the radio communication means intermittently sends the transmission request data generated by the transmission request data generating means to the notifying device at an interval assigned in advance to the portable terminal device, and also receives the notification data sent to the portable terminal device.

8. A portable terminal device according to claim 7, further comprising an instruction input receiving means for receiving an instruction inputted by a user,
wherein, when the instruction input receiving means receives the request regarding any section among a plurality of sections to be monitored which are included in the vehicle from the user, the transmission request data generating means generates transmission request data having a content corresponding to the request.

9. A portable terminal device according to claim 8, wherein the control means controls the radio communication means such that the radio communication means performs the intermittent transmission while maintaining a first interval after synchronization with the notifying device is established, and performs the intermittent transmission at a second interval shorter than the second interval in an emergency case where an instruction inputted by the user is received.

10. A portable terminal device according to claim 7, further comprising a visualization means whose operation is controlled by the control means, and which visually notifies the user of the vehicle state indicated by the received notification data.

11. (canceled)

12. A vehicle state notifying method, which is executed by a notifying device and a portable terminal device each having a radio communication means for performing bidirectional intermittent communication by using weak power which is not restricted by a law, the method comprising the steps of:
intermittently sending, by the portable terminal device, transmission request data, to the notifying device, to request for transmission of notification data indicating a current state of a vehicle to be monitored, at an interval assigned to the portable terminal device;
establishing, by the notifying device, synchronization of intermittent communication with the portable terminal device upon reception of the transmission request data, and intermittently sending notification data having a predetermined data structure indicating a detection result regarding the vehicle state obtained through detection of a predetermined sensor, at an interval at which the portable terminal device, which has established synchronization, can receive the notification data; and
notifying, by the portable terminal device, after receiving the notification data, the user of the vehicle state identified by the notification data, by visually expressing the vehicle state.
